(19) United States
(12) Patent Application Publication
(10) Pub. No.: US 2017/0307480 A1
(43) Pub. Date: Oct. 26, 2017

(54) Data Display System

(71) Applicant: Hitachi, Ltd., Chiyoda-ku, Tokyo (JP)

(72) Inventors: Takayuki UCHIDA, Tokyo (JP); Shigetoshi SAKIMURA, Tokyo (JP); Kazuyuki TAKADO, Tokyo (JP); Takahiro FUJISHIRO, Tokyo (JP); Tomoaki HIRUTA, Tokyo (JP)

(73) Assignee: Hitachi, Ltd., Chiyoda-ku, Tokyo (JP)

(21) Appl. No.: 15/501,999

(22) PCT Filed: Oct. 6, 2015
(86) PCT No.: PCT/IB2015/057622

§ 371 Date: Jun. 28, 2017

(30) Foreign Application Priority Data
Aug. 7, 2014 (JP) 2014-160938

(51) Int. Cl. G01M 99/00; G06F 3/147; G06T 11/20

(52) U.S. Cl. CPC G01M 99/008; G06F 3/147; G06T 2200/24; G06T 11/206

(57) ABSTRACT

To improve diagnostic accuracy in diagnosing for abnormality of a machine, it is necessary to adjust a parameter regarding diagnosis such as the number of clusters. In such an adjustment operation, each time a diagnostic parameter is modified, a checking operation by an analysis operator is required to see whether a diagnosis result has been improved. The present invention assists in the checking operation to see whether diagnostic accuracy has been improved by comparing diagnosis results before and after parameter modification. If there are many items of sensor data for diagnosis, many items of abnormality degree data arise as analysis result. Many items of data pose a problem that comparing diagnosis results takes time. In the data display system, abnormality degree data that has changed largely before and after parameter modification is automatically found and displayed to the analysis operator. How much an abnormality degree has changed is determined as an abnormality degree change rate, i.e., a ratio between “abnormality degree difference due to change” and “modified parameter value difference”. Only abnormality degree data with a large change rate is displayed to the analysis operator. Additionally, a more suited parameter that was hidden, if found during a parameter modifying operation, is displayed and presented to the analysis operator.

### TECHNICAL FIELD

The present invention relates to a technology to assist improving diagnostic accuracy in diagnosing for abnormality of a machine.

### BACKGROUND ART

Machine maintenance work is necessary to make a machine, such as a gas engine, an elevator, an excavation machine, and an architecture equipment operate at all times. As one of technologies that are effective for maintenance work, there is a technology that collects sensor data from sensors installed on respective parts of a machine, diagnoses for abnormality of the machine from the collected sensor data, and, if an abnormality has been found, analyzes a cause thereof.

To implement that technology, a method is available that represents sensor data on a machine and a data appearance frequency with a scatter diagram or a histogram and checks for abnormality of the machine from an outlier in an appearance frequency distribution thus obtained.

For example, FIG. 16 is a drawing representing a balance between engine temperature and cooling water pressure of a machine with a scatter diagram. This drawing represents a scatter diagram of temperature and pressure for a period when the machine was operating normally with a set of circles 16110 called clusters. A technology of making such clusters from a scatter diagram is called clustering and it is a publicly known technique in machine learning and data mining fields. Making clusters is called “learning” in a machine learning field. A distance 16120 from the clusters is calculated as a degree of abnormality, i.e., an abnormality degree and compared with a threshold value of abnormality degree; if it is larger, the machine is diagnosed to be abnormal.

While performing such learning and diagnosis, if a change is made to a parameter such as the number of clusters and a period when the machine was operating normally, a change occurs like an abnormality degree 16200 in FIG. 16. Hence, it is necessary to adjust these diagnostic parameters when performing a diagnosis. FIG. 15 illustrates an example of an operation of adjusting a diagnostic parameter. Sensor data is collected from a machine 15000 subject to diagnosis in FIG. 15 and sent to a computer 15150 for abnormality diagnosis illustrated in FIG. 16. With this computer 15150, an analyst 15300 who adjusts diagnostic parameters performed abnormality diagnosis once and a result of the diagnosis is a graph 15400 of abnormality degree. Because the abnormality degree mentioned in FIG. 16 can be calculated per unit time, the abnormality degree can be represented as a time series graph 15400 as time series trend data.

To improve the diagnostic accuracy of abnormality diagnosis of the graph 15400, a check is made whether large and small abnormality degrees correspond with actual abnormality and normality and, if not, it is required to modify a diagnostic parameter such as the number of clusters. In particular, from a maintenance history recorded by a maintenance person 15200, a check is made whether an abnormality degree becomes high for a period when the machine was abnormal. Then, as in a graph 15400, if a period when an abnormality degree is too low or a period when an abnormality degree is too high is found, whereas there remains a record indicating abnormality for that period in the maintenance history, a parameter is modified. When the parameter has been modified successfully, the abnormality degree for a period when the abnormality degree is too low or too high is modified and the diagnostic accuracy can be improved.

In this operation of modifying a parameter, it is required to perform a checking operation repeatedly; once a parameter has been modified, a check is made whether the diagnostic accuracy can be improved by comparing a graph 15500 and a graph 15400 before modification; and, when a parameter is modified again, a check is made whether the diagnostic accuracy can be improved.

A data display device to solve above-mentioned problems are, for example, found in Patent Document 1. This Document concerns an invention that selects a diagnostic parameter when calculating an abnormality degree, calculates an abnormality degree, and displays its trend data. Using this invention, by carrying out the above operation of modifying a parameter, it is possible to improve diagnostic accuracy.

### CITATION LIST

### Patent Document

Patent Document 1: Japanese Unexamined Patent Application Publication No. 2013-152655

### SUMMARY OF THE INVENTION

### Technical Problem

If there are a lot of data items of trend data of abnormality degree, the invention of Patent Document 1 involves a problem in which it is not known what period of abnormality degree trend for which an abnormality degree has been improved by modifying a parameter, unless scrolling a graph and checking.

### Solution to Problem

To solve the above-described problem, a data display system of the present invention includes a storage unit that stores data from sensors installed on a machine; a parameter setting unit that accepts input of a parameter for processing the data; a diagnosis unit that displays, on a display unit, results of processing of the data allowed to be compared before and after modifying a parameter; and a display data filtering calculation unit that changes a scope of data to display for comparison by selecting a criterion to filter data to display by an analysis operator to analyze the data.

The data display system of the present invention is further wherein the display data filtering calculation unit changes the scope of data to display according to an extent to which a parameter is modified, specified as a criterion to filter data to display, and a result of processing of the data by modifying the parameter.

The data display system of the present invention is further wherein the display data filtering calculation unit takes it as a criterion to filter data to display that a value change has occurred in a trend graph before and after parameter adjustment.

The data display system of the present invention is further wherein the display data filtering calculation unit takes a change of an abnormality degree change rate before and after parameter adjustment as a criterion to filter data to display.

The data display system of the present invention is further wherein the display data filtering calculation unit takes a ratio of a change amount of abnormality degree to a change amount of a parameter as a criterion to filter data to display.

The data display system of the present invention is further wherein the display data filtering calculation unit takes it as a criterion to filter data to display that an abnormality degree has been made larger or smaller than a specified threshold value by the parameter adjustment.

The data display system of the present invention is further wherein the display data filtering calculation unit takes it as a criterion to filter data to display that an abnormality degree change before and after parameter adjustment is not monotonically increasing or decreasing.

The data display system of the present invention is further wherein the display data filtering calculation unit takes it as a criterion to filter data to display that the machine is in a specified operating mode.

The data display system of the present invention is further wherein the specified operating mode is a transient period during startup of the machine or an idling period.

### Advantageous Effects of the Invention

According to the data display system of the present invention, abnormality degree tread data narrowed to only abnormality degree data that satisfies a specified condition is displayed. This enables it to quickly find a period in which an abnormality degree graph has changed before and after modifying a diagnostic parameter. Thereby, assisting in an operation of improving diagnostic accuracy by modifying a diagnostic parameter can be realized.

Problems, configurations, and advantageous effects other than described above will be apparent from the following description of an embodiment.

### BRIEF DESCRIPTION OF THE DRAWINGS

FIG. 1 is an overall configuration diagram including a data display system pertaining to an exemplary embodiment of the present invention.

FIG. 2 is a flowchart of the exemplary embodiment.

FIG. 3 is a display example of a screen for inputting diagnostic parameters pertaining to the exemplary embodiment.

FIG. 4 is an example of a screen displaying an abnormality degree graph as a diagnosis result pertaining to the exemplary embodiment.

FIG. 5 is a display example of a screen for resetting diagnostic parameters pertaining to the exemplary embodiment.

FIG. 6 is an example of a screen displaying an abnormality degree graph as a diagnosis result pertaining to the exemplary embodiment and displaying the previous diagnosis result and the current diagnosis result together.

FIG. 7 is a display example of a screen for setting narrow down conditions for display pertaining to the exemplary embodiment.

FIG. 8 is a display example of a screen in which diagnosis result data is narrowed down pertaining to the exemplary embodiment and a screen example of displaying the previous diagnosis result and the current diagnosis result together.

FIG. 9 is a flowchart of the exemplary embodiment.

FIG. 10 is a flowchart of the exemplary embodiment.

FIG. 11 is a flowchart of the exemplary embodiment.

FIG. 12 is a drawing to explain a data structure of data that a parameter management unit stores pertaining to the exemplary embodiment.

FIG. 13 is a drawing to explain a data structure of data that a maintenance history storing unit stores pertaining to the exemplary embodiment.

FIG. 14 is a drawing to explain a data structure of data that a trend data storing unit stores pertaining to the exemplary embodiment.

FIG. 15 is a drawing to explain general practice of diagnostic parameter adjustment and diagnosis result checking.

FIG. 16 is a drawing to explain about diagnostic parameter adjustment that is practiced generally.

FIG. 17 is an explanatory diagram about a hidden loopback parameter.

FIG. 18 is an explanatory diagram about a principle of judging whether a hidden loopback parameter exists according to the exemplary embodiment.

### DESCRIPTION OF THE EMBODIMENTS

In the following, an embodiment of the present invention will be described by way of the drawings.

### Embodiment

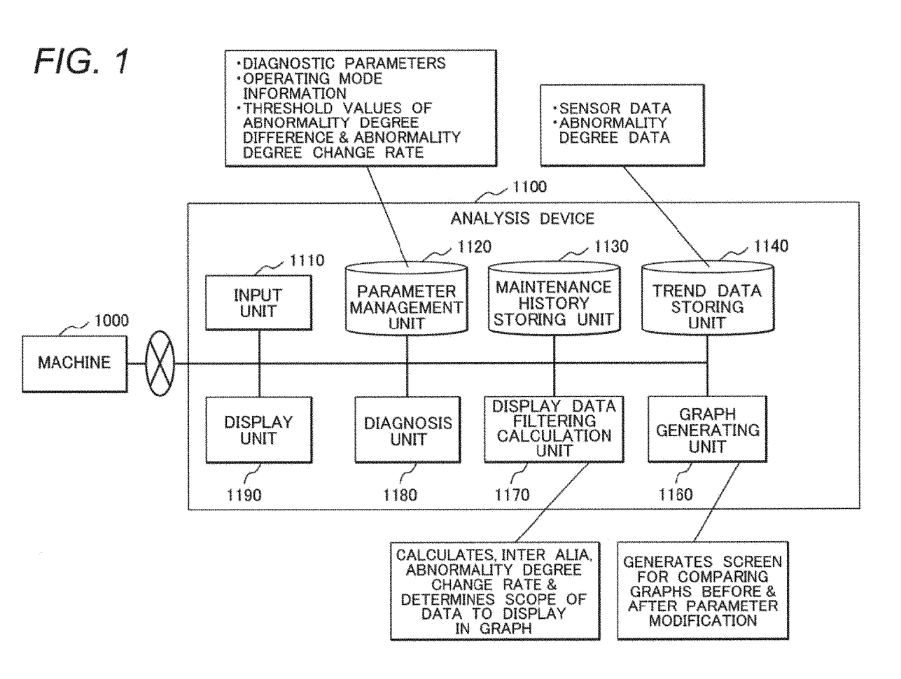

FIG. 1 depicts an overall configuration of an embodiment of the present invention.

A machine 1000 is a machine comprised in, e.g., railroad or construction equipment. Values of, e.g., engine pressure, cooling water temperature, and revolving speed are measured from sensors installed on respective parts of the machine and sent to an analysis device 1100. Internal parts of the analysis device 1100 are described below.

An input unit 1110 is comprised of a keyboard, a mouse, a touch panel, etc. and is a device that is used for inputting diagnostic parameters.

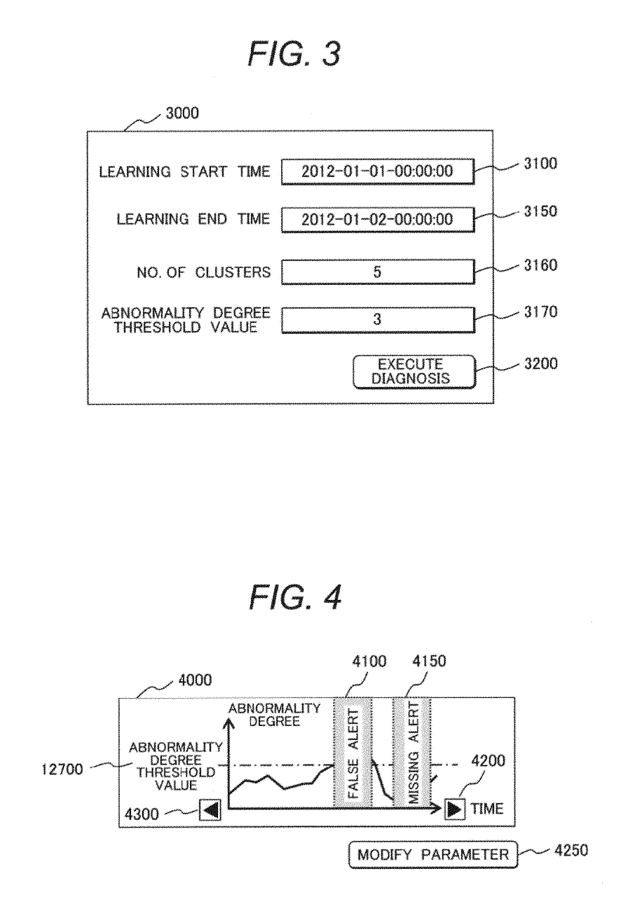

A display unit 1190 is comprised of a liquid crystal display or the like and is a device that displays screens illustrated in FIGS. 3 through 8, which will be described later.

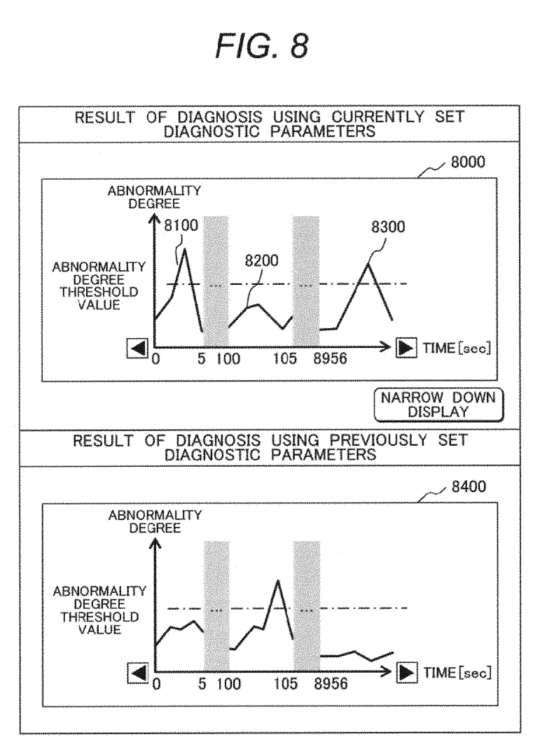

A parameter management unit 1120 stores diagnostic parameters and information set for a criterion to narrow down and display data, as in FIG. 8, which will be described later. Information to be stored includes diagnostic parameters such as the number of clusters, a conditional expression for judging what operating mode in which the machine is now operating, and the threshold values of abnormality degree difference and abnormality degree change rate.

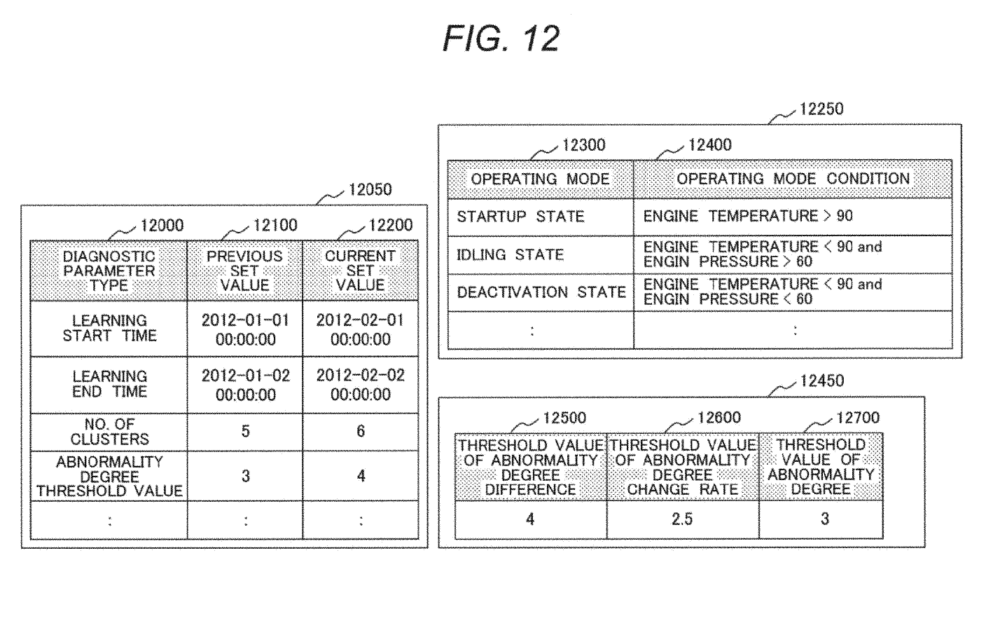

FIG. 12 illustrates a data table structure storing these items of information.

A data table structure 12050 in FIG. 12 stores entries for diagnostic parameter type 12000 and set values of a parameter before being modified 12100 and after being modified 12200.

A data table structure 12250 in the same figure stores a conditional expression 12400 for judging what operating mode 12300 in which the machine is now operating. A conditional expression is composed of an inequality or the like that can be calculated from the value of each sensor. When each conditional expression given in the column of conditional expression 12400 is fulfilled, it can be judged that the machine is operating in the operating mode 12300 associated with the conditional expression.

A data table structure 12450 in FIG. 12 stores a threshold value 12700 for judging whether an abnormality degree is abnormal or normal and information corresponding to threshold values 12500, 12600 of narrow down conditions a), b) to display abnormality degree data, referred to in the “Solution to Problem” section.

A threshold value 12500 of a narrow down condition a) is a threshold value of a trend graph change amount for a period when a value in a trend graph changed greatly before and after parameter adjustment. If an abnormality degree change amount is beyond a value of the threshold value 12500 before and after parameter modification, a display is made as in FIG. 8.

A threshold value 12600 of b) is a threshold value of an abnormality degree change rate=a ratio of “a change amount of abnormality degree/a change amount of a parameter” before and after parameter adjustment. This is a condition on a natural assumption that, when a parameter has been changed greatly (an amount of change is large), an abnormality degree trend graph also changes largely.

Only abnormality degree data for which this change rate is beyond a value of the threshold value 12600 of abnormality degree change rate is displayed, as in FIG. 8.

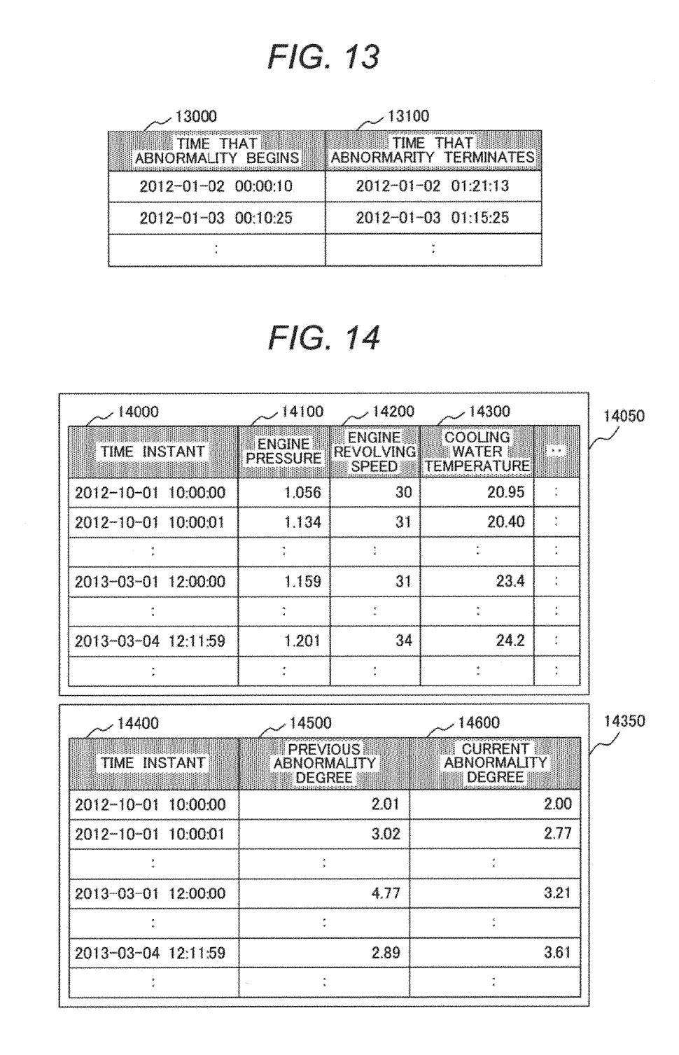

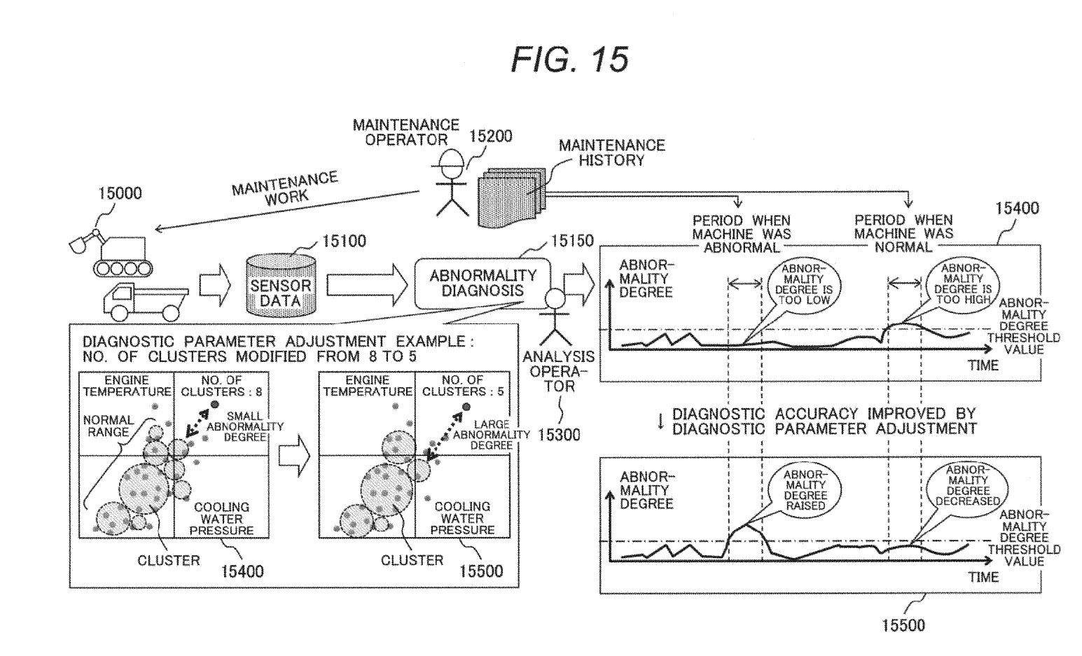

A maintenance history storing unit 1130 in FIG. 1 stores history information regarding periods when the machine was abnormal. This history information is updated daily by a maintenance operator or the like through the input unit 1110. Its data structure is comprised of a start time and an end time of a period when the machine was abnormal, as in FIG. 13. By performing a search to see whether a time falls between the time 13000 and the time 13100, it can be judged whether the machine was normal at that time.

A trend data storing unit 1140 in FIG. 1 is a database storing data sensed by sensors such as engine pressure and revolving speed measured from the machine 1000 comprised in, e.g., railroad or construction equipment. It also stores abnormality degree data which is a result of a diagnosis using such sensor data. Its table structure is like an upper table 14050 in FIG. 14. In this table, sensor data, i.e., engine pressure 14100, engine revolving speed 14200, and cooling water temperature 14300 are stored, associated with time 14000 of their measurement. Sensor data in an arbitrary time range can be searched for. A lower table 14350 in the same figure stores abnormality degree trend data which is a result of a diagnosis using the sensor data in the table 14050. In the table 14350, an abnormality degree 14500 which is an abnormality degree before modifying a diagnostic parameter and an abnormality degree 14600 after the parameter is modified are managed, associated with time 14400. As is the case for the table 14050, abnormality degree data in an arbitrary time range can be searched for.

A graph generating unit 1160 in FIG. 1 plots abnormality degree data as diagnosis results in separate graphs before and after parameter modification, as in FIG. 8. A graph before parameter modification is a lower graph 8400 in FIG. 8 and a graph after parameter modification is an upper graph 8000.

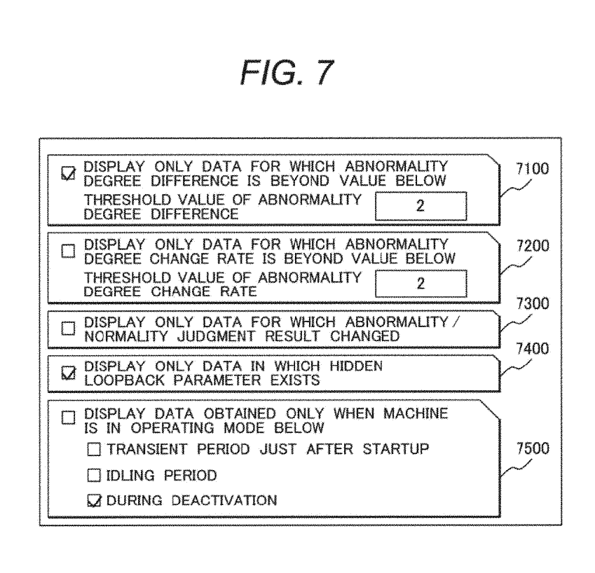

A display data filtering calculation unit 1170 in FIG. 1 calculates, inter alia, an abnormality degree change rate, determines a scope of data to display in a graph, and determines whether to display data with respect to each value of abnormality degree. Conditions to narrow down and display data are set by checking narrow down conditions for display that the operator wants to enable on a screen in FIG. 7 from a threshold value 7100 that the analysis operator may set up to a condition for display 7500.

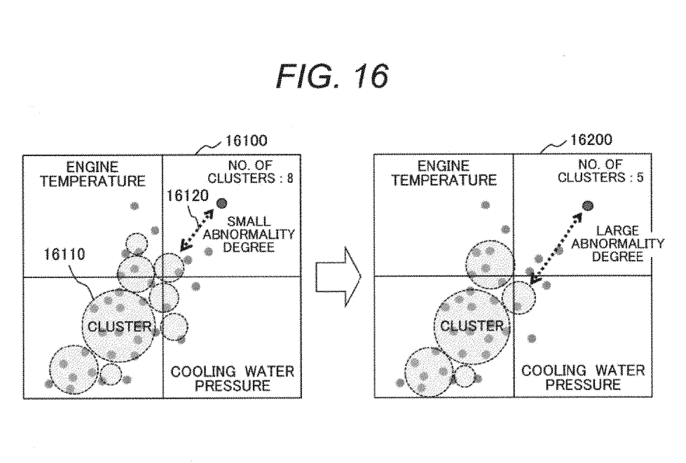

A diagnosis unit 1180 in FIG. 1 executes a diagnosis, using diagnostic parameters in the parameter management unit 1120 and data in the trend data storing unit 1140, and calculates an abnormality degree. For a calculation method, a method through the use of clustering illustrated with FIG. 16 may be used.

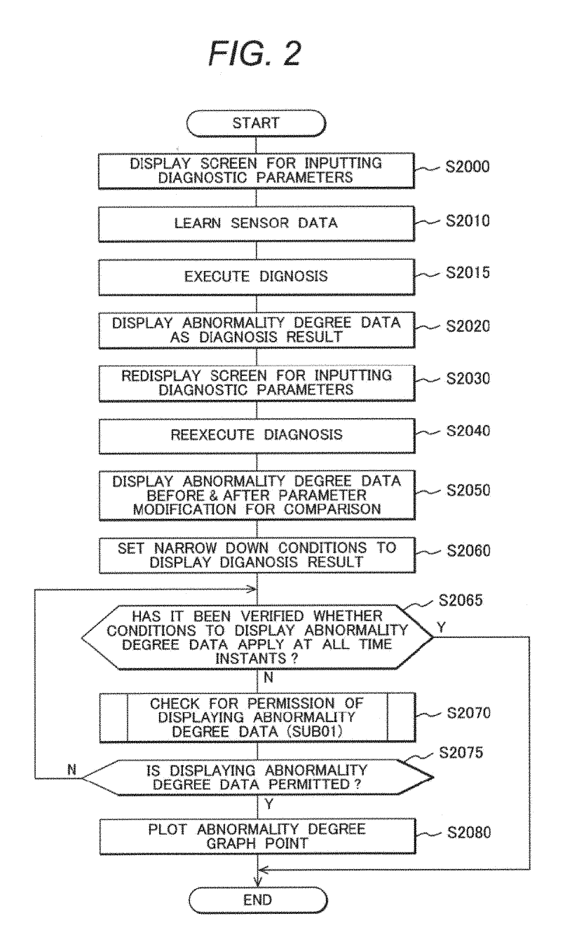

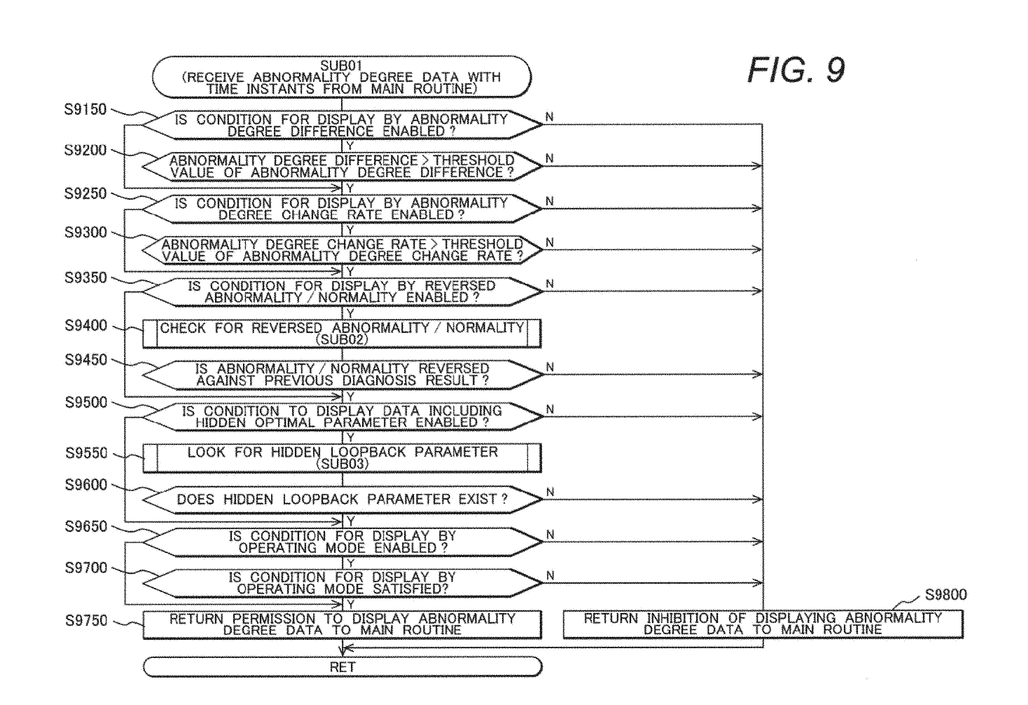

Then, a process that is performed in the present embodiment is described with flowcharts. A main flow is illustrated in FIG. 2 and subroutines that are called from FIG. 2 are illustrated with FIGS. 9, 10, and 11.

At step 2000 (hereinafter labeled as S2000) in the main routine in FIG. 2, the process displays an input screen 3000 in FIG. 3 which is a screen for inputting diagnostic parameters. The input screen 3000 allows an analysis operator to input diagnostic parameters such as learning start time 3100 and the number of clusters. Pressing Execute Diagnosis 3200 by the analysis operator executes a diagnosis based on the input diagnostic parameters.

At S2010 and S2015, the process executes a diagnosis and calculates an abnormality degree by the method illustrated with FIG. 16.

First, at S2010, the process makes clusters and learns data during normal operation. The process loads sensor data between the learning start time 3100 and the learning end time 3150 in FIG. 3 from the table 14050 in FIG. 14. From the loaded data, the process calculates a cluster center and radius according to the number of clusters 3160.

At S2015, the process calculates an abnormality degree that is a distance from the cluster center for each sensor value of sensor data for diagnosis. The process stores the calculated abnormality degree into a column of abnormality degree (previous abnormality degree) 14500, which is an abnormality degree before modifying a diagnostic parameter, within the lower table 14350 in FIG. 14.

At S2020, the process displays a graph of abnormality degree data thus calculated as in FIG. 4 and also evaluates whether large and small abnormality degrees are true through the use of the maintenance history unit 1130. The process displays a false alert and a missing alert for periods for which a diagnosis result is incorrect, as in a screen display 4100, 4150. Here, false and missing alerts are defined below.

False alert: the abnormality degree is above or at the abnormality degree threshold value 12700, whereas no abnormality occurs according to the maintenance history.

Missing alert: the abnormality degree is less than the abnormality degree threshold value 12700, whereas an abnormality occurs according to the maintenance history.

A period when an abnormality degree exceeds the abnormality degree threshold value does not correspond with the period recorded as an abnormal period in the maintenance history; such period is a period for which a false or missing alert should be displayed. The process displays the result as in FIG. 4.

To eliminate this false or missing alert, pressing the Modify Parameter button 4250 by the user makes the process proceed to a next step S2030.

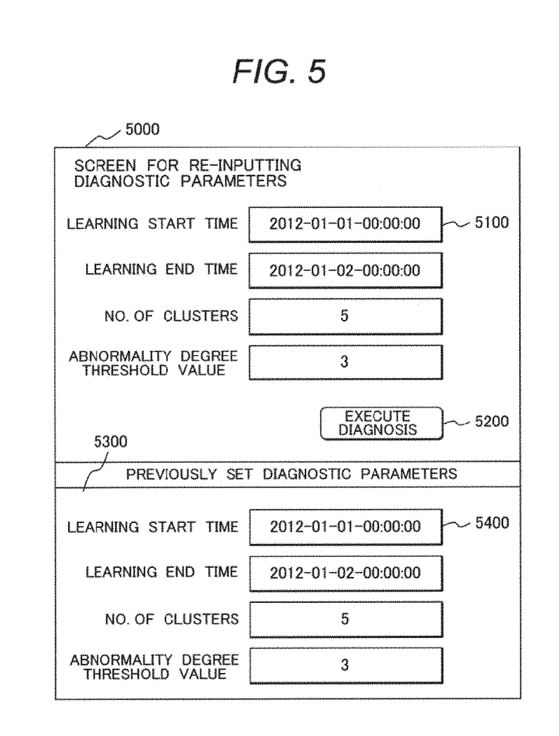

At S2030, the process displays a screen for re-inputting diagnostic parameters, while comparing it with the diagnostic parameters which were input at S2000, as in FIG. 5. Diagnostic parameters which may be re-input are displayed on an upper display screen 5000 and diagnostic parameters which are previously input at S2000 are displayed on a lower display screen 5300. After re-inputting a diagnostic parameter, the analysis operator presses the Execute Diagnosis button 5200 to reexecute a diagnosis.

At S2040, the process reexecutes the processing operations performed at S2050 and S2020, using a diagnostic parameter that was re-input on the screen 5000 in FIG. 5. The process stores an abnormality degree calculated by reexecution into a column of abnormality degree (current abnormality degree) 14600 after modification within the lower table 14350 in FIG. 14.

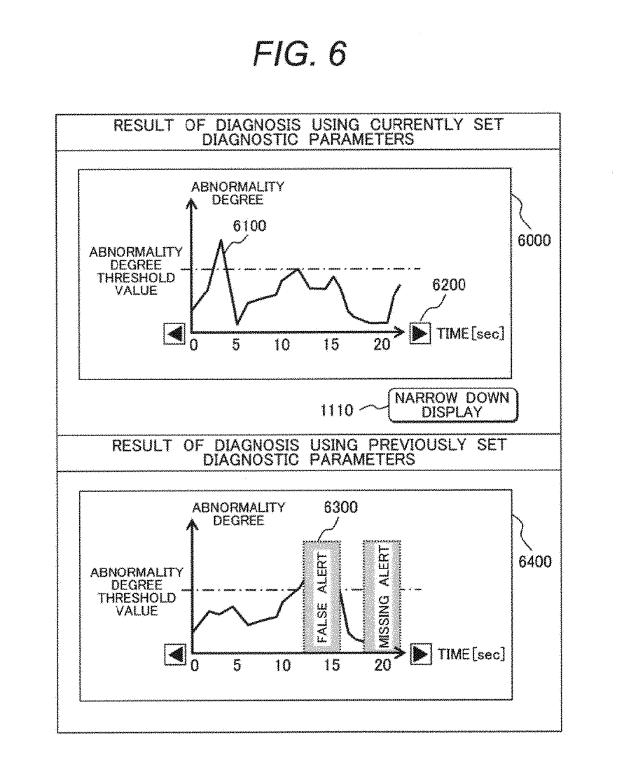

At S2050, the process displays stored abnormality degree data in separate graphs for comparison: a graph 6000 after parameter modification and a graph 6400 before the modification, as in FIG. 6. A lower graph 6400 presented in FIG. 6 shows abnormality degree data before parameter modification, i.e., the same information as in FIG. 4. Abnormality degree data that is displayed in the upper graph 6000 presented in FIG. 6 is loaded from the column of abnormality degree (current abnormality degree) 14600 after modification within the lower table 14350 in FIG. 14, in which the data was stored at S2040, and displayed. If the number of items of abnormality degree data is large in S2050, at S2060, the analysis operator sets narrow down conditions to narrow down data to be displayed.

At S2060, the process displays a setting screen for specifying narrow down conditions to display abnormality degree data, as in FIG. 7 referred to previously.

In FIG. 7, narrow down conditions 7100 through 7500 correspond to narrow down conditions to display abnormality degree data. Whether or not to enable each narrow down condition can be specified with a checkbox. Besides, a threshold value of abnormality degree difference for a narrow down condition 7100 and a threshold value of abnormality degree change rate for a narrow down condition 7200 are settable.

Additionally, for a narrow down condition 7500, an operating mode of a machine for which abnormality degree data is displayed can be selected from a list of operating modes. This list of operating modes is data loaded from the column of operating mode 12300 in FIG. 12. When the analysis operator has set one or more of the narrow down conditions and/or the threshold values, the process proceeds to S2065. S2065 through S2075 that follow are a flow to judge whether abnormality degree data at each time instant satisfies one or more narrow down conditions which were set in FIG. 7.

S2065 is an operation to check the following: it has been verified whether one or more narrow down conditions to display abnormality degree apply with respect to abnormality degree points of all time instants. If such check is complete with respect to abnormality degree points of all time instants, the process terminates the present main routine. If not so, the process proceeds to S2070.

S2070 calls a subroutine SUB01 that judges whether or not to permit displaying data and returns a result so that the process will judge whether displaying abnormality degree data at a time instant, now under check, is permitted. This step calls SUB01 with an argument of an abnormality degree at the oldest time instant. A process within SUB01 will be described later.

S2075 makes the process return to S2065, if no permission to display data has been returned in S2070, and the process judges whether or not to permit displaying next abnormality degree data. If permission to display data has been returned, the process proceeds to S2080.

At S2080, the process plots an abnormality degree point for which displaying data was permitted. By repeating S2070 through S2080, it is possible to display an abnormality degree graph in which only periods to be noted by the analysis operator are emphasized and displayed, as in FIG. 8.

In the following, SUB01 in FIG. 9 is described. From a value in the column of abnormality degree (previous abnormality degree) 14500 in FIG. 14, which is an abnormality degree at a time instant before modifying a diagnostic parameter, and a value in the column of abnormality degree (current abnormality degree) 14600 after modification at the same time instant, SUB01 judges whether abnormality degree data at that time instant should be displayed in FIG. 8. If it has been judged that such data should not be displayed, the process proceeds to S9800 and returns no permission to display data to the main routine. And now, this judgment is made only for one or more narrow down conditions for display which were checked and enabled in FIG. 7.

If a condition by abnormality degree difference is enabled at S9150, the process proceeds to S9200. If an absolute value of “a value in the column of abnormality degree 14600—a value in the column of abnormality degree 14500” at the same time instant in FIG. 14 is larger than the threshold value of abnormality degree difference which was input for the narrow down condition 7100 in FIG. 7, the process proceeds to S9250.

If a narrow down condition 7200 for display by abnormality degree change rate is enabled at S9250, the process proceeds to S9300.

At S9300, the process calculates an abnormality degree change rate=“a change amount of abnormality degree/a change amount of a parameter” and, if the calculated rate is larger than the threshold value of abnormality degree change rate 12600 in FIG. 12, the process permits displaying data and proceeds to S9350. Because a numerator in calculating the abnormality degree change rate is a change amount of abnormality degree, it can be calculated similarly as in S9200. A change amount of a parameter as a denominator can be calculated from a difference between a previous set value 12100 and a current set value 12200 for the parameter in FIG. 12.

At S9350, if the narrow down condition 7300 for display in FIG. 7 is checked, the process proceeds to S9400.

S9400 calls a subroutine SUB02 and judges whether the larger/smaller relation between the abnormality degree and the threshold value has changed before and after parameter modification. A process within SUB02 will be described later.

At 9450, if the larger/smaller relation between the abnormality degree and the threshold value has changed from the result of judgment in S9350, the process permits displaying data and proceeds to S9500.

At 9500, the process judges whether a narrow down condition 7400 in FIG. 7 is enabled and, if it is enabled, the process proceeds to S9550.

At S9550, it is judged whether a hidden loopback parameter exists by a subroutine SUB03.

A process within SUB03 will be described later.

At S9600, if a hidden loopback parameter exists, as judged by SUB03, the process permits displaying data and then proceeds to S9650.

At S9650, the process judges whether a narrow down condition 7500 for display by operating mode in FIG. 7 is enabled. If it is enabled, the process proceeds to S9700.

At S9700, the process judges whether an operating mode checked under the narrow down condition 7500 is true by referring to sensor data at the same time instant as a time instant 14440 of abnormality degree and from sensor data in terms of engine pressure 14100 (FIG. 14), engine revolving speed 14200 (FIG. 14), cooling water pressure 14300 (FIG. 14), etc. A judgment method is to search for an operating mode condition 12400 (FIG. 12) associated with the checked operating mode and, in its conditional expression, assigns sensor data in terms of engine pressure 14100, engine revolving speed 14200, and cooling water pressure 14300, thus judging whether the operating mode is true. As a result of the judgment, if the operation mode checked under the narrow down condition 7500 is true, the process permits displaying data and proceeds to S9750.

At S9750, the process has permitted displaying data in terms of all conditions for display and, therefore, issues a permission to display data to the main routine and terminates SUB01.

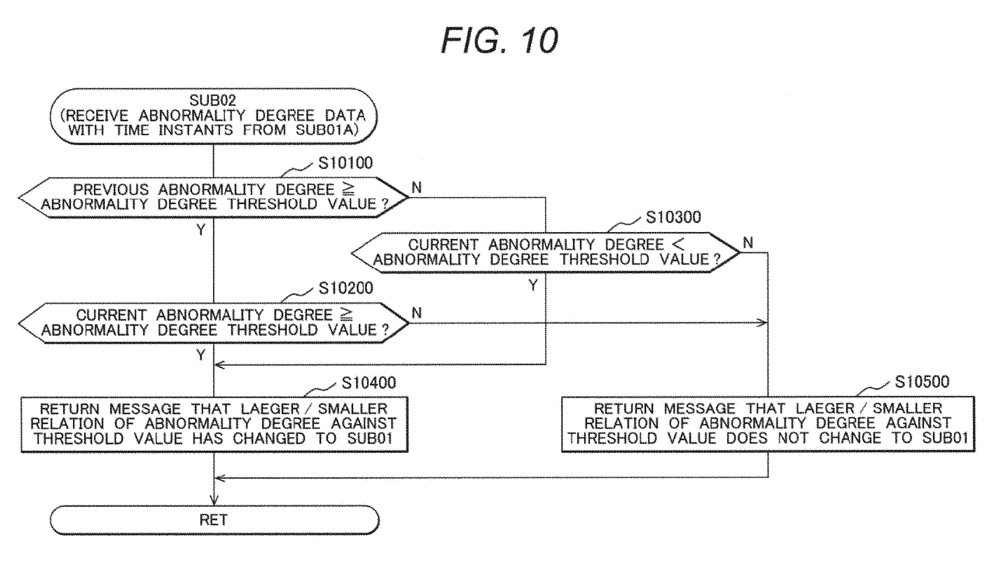

Then, the process within SUB02 that is called from S9400 is described with FIG. 10. SUB02 is a subroutine that judges whether the larger/smaller relation between the abnormality degree and the threshold value has changed before and after parameter modification. In particular, this judgment is made by a condition of whether each value of abnormality degree stored in the column of abnormality degree (previous abnormality degree) 14500, which is an abnormality degree before modifying a diagnostic parameter, and in the column of abnormality degree (current abnormality degree) 14600 after modification within the lower table 14350 in FIG. 14 is larger or smaller than the abnormality degree threshold value 12700 in FIG. 12. Conditional expressions for this judgment are as follows:

A) A condition for a judgment that the larger/smaller relation does not change satisfies A-1) or A-2) below:
A-1) Abnormality degree 14500≧Abnormality degree threshold value 12700 and
   Abnormality degree 14600≧Abnormality degree threshold value 12700
A-2) Abnormality degree 14500<Abnormality degree threshold value 12700 and
   Abnormality degree 14600<abnormality degree threshold value 12700
      B) A condition for a judgment that the larger/smaller relation has changed satisfies B-1) or B-2) below:
B-1) Abnormality degree 14500≧Abnormality degree threshold value 12700 and
   Abnormality degree 14600<Abnormality degree threshold value 12700
B-2) Abnormality degree 14500<Abnormality degree threshold value 12700 and
   Abnormality degree 14600≧abnormality degree threshold value 12700

FIG. 10 illustrates a flow for judging the above conditions. Through this flow, the process judges which conditions A-1), B-1) or conditions A-2), B-2) given above are true at S10100 and further judges which A-1) or B-1) or which A-2) or B-2 is true at S1030 and S10200.

If A-1) or A-2) is true, the process returns a message that the larger/smaller relation of the abnormality degree against threshold value has changed to SUB01 at S10400.

If B-1) or B-2) is true, the process returns a message that the larger/smaller relation does not change to SUB01 at S10500.

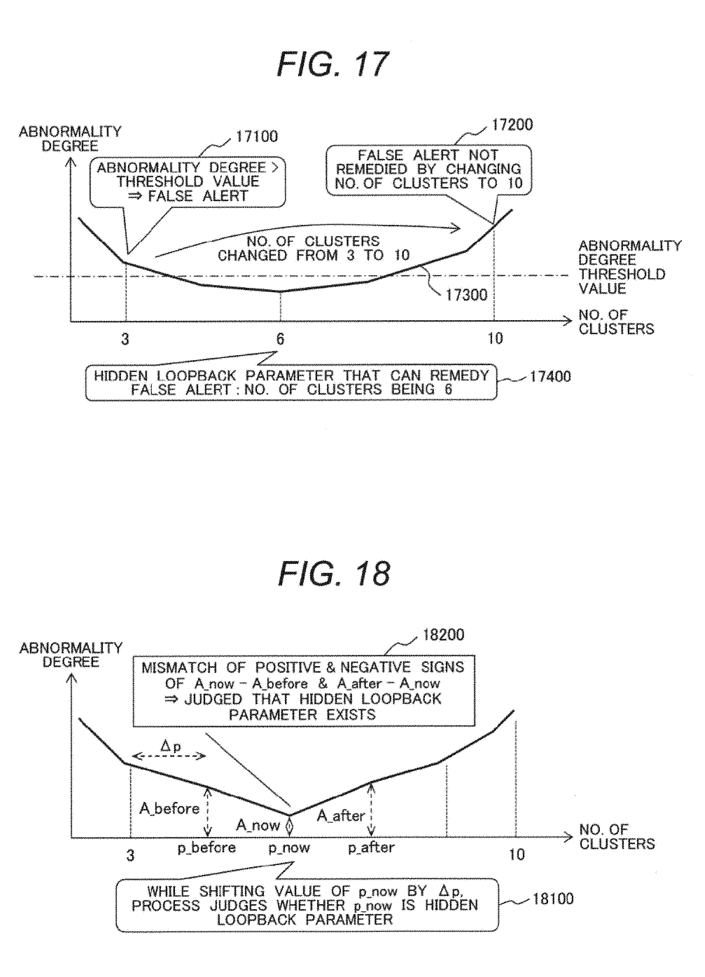

Then, the process within SUB03 that is called from S9550 is described. SUB03 is a flow for judging whether a hidden loopback parameter which can further reduce the occurrence of false and missing alerts hides between the original and modified values of a diagnostic parameter. If a hidden loopback parameter hides, SUB03 returns permission to display abnormality degree data to SUB01. A hidden loopback parameter is explained with FIG. 17.

In FIG. 17, by way of example, the number of clusters was modified to 10 to reduce the possibility of a false alert which occurs when the number of clusters is 3, but the abnormality degree does not decrease and the possibility of a false alert was not reduced. This is an instance where a hidden loopback parameter 6 really hides between the number of clusters being 3 and the number of clusters being 10 and an optimal number of clusters being 6 is unnoticed when the parameter is modified. Such a hidden loopback parameter occurs due to the fact that the abnormality degree does not increase or decrease monotonically between the number of clusters being 3 and the number of clusters being 10. A method of judging whether such a hidden loopback parameter exists between the original and modified values of a parameter is described with FIG. 18.

In FIG. 18, the original parameter value of 3 (the number of clusters being 3) and the modified parameter value of 10 (the number of clusters being 10 are placed at both ends and a range between those values is partitioned by step size Δp of the diagnostic parameter. Setting Δp smaller increases the probability of detecting a hidden loopback parameter; at the same time, the number of times calculation is to be executed for judgment increases and a total calculation time becomes longer. Thus, step size should be determined depending on the specifications of a computer.

The judgment method is as follows: move a diagnostic parameter value p_now in FIG. 18 by step Δp between 3 and 10 as the number of clusters; and it can be judged that p_now is a hidden loopback parameter, if there is a mismatch of the positive and negative signs of a difference “A_now−A_before” relative to an abnormality degree plotted for a diagnostic parameter value p_before just preceding p_now and a difference “A_after−A_now” relative to an abnormality degree plotted for p_after just following p_now.

SUB03 is a flow for judging whether this hidden loopback parameter exists between values set for the previous set value 12100 and the current set value 12200 in FIG. 12. If any one hidden loopback parameter exists, the process returns permission to display abnormality degree data in FIG. 8 to SUB01.

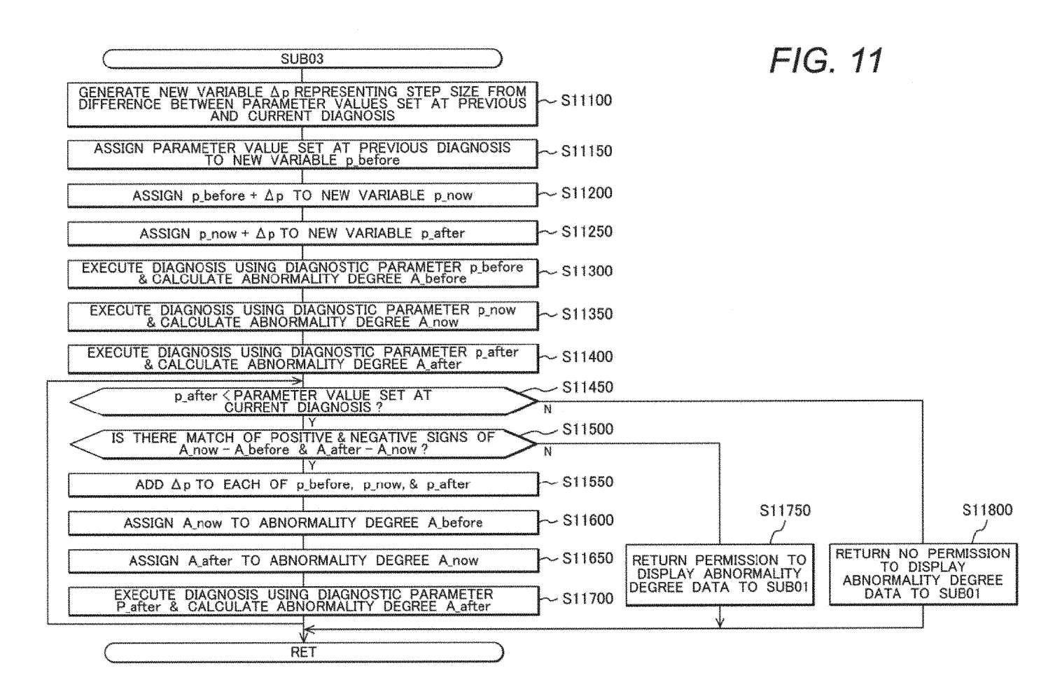

Then, a description is provided about SUB03 with FIG. 11.

S11100 in FIG. 11 generates step size Δp from values set for the previous set value 12100 and the current set value 12200 in FIG. 12. This step size should be determined by the specifications of a computer, as noted previously. S11150 through S11250 initialize variables p_before, p_now, and p_after representing a diagnostic parameter such as the number of clusters. These variables are initialized so that a difference between them becomes equal to Δp.

S11300 through S1140 initialize variables A_before, A_now, and A_after representing an abnormality degree.

As illustrated in the flow, an initial value thus set is an abnormality degree for each variable calculated using each value of the variables p_before, p_now, and p_after of a diagnostic parameter (the number of clusters).

At S11450, while shifting p_now by Δp, the process checks to see whether a condition to terminate the operation of judging whether p_now is a hidden loopback parameter is satisfied. If P_after is not beyond a value set for the current set value 12200 in FIG. 12 which is an upper limit value of the diagnostic parameter, the process proceeds to S11500; if not so, a hidden loopback parameter is regarded as non-existent and, therefore, the process proceeds to S11800, returns a message of no permission to display abnormality degree data to SUB1, and terminates the present subroutine.

At S11500, the process checks whether there is a match of the positive and negative signs of abnormality degree differences described with FIG. 18. If there is a mismatch of the signs, a hidden loopback parameter has been found successfully and, therefore, the process proceeds to S11750 and returns a permission to display data to SUB01. After that, the process terminates the present subroutine. If there is a match of the signs, it has been judged that p_now is not a hidden loopback parameter and therefore, the process proceeds to an operation of making a judgment for a next value of the diagnostic parameter.

S11550 is an operation of adding Δp to each of p_before, p_now, and p_after to make a judgment for a next value of the diagnostic parameter.

S11600 and S11650 are an operation of updating abnormality degree values A_before and A_now to respond with adding Δp to the diagnostic parameter values.

S11700 executes a diagnosis using p_after, calculates an abnormality degree, and assigns a result to A_after in order to update A_after. After that, the process returns to S11450 and process to a next judgment operation.

A series of the processes of the embodiment of the present invention is now complete.

### REFERENCE SIGNS LIST

1000 Machine,
1100 Analysis device,
1110 Input unit,
1120 Parameter management unit
1130 Maintenance history storing unit
1140 Trend data storing unit
1160 Graph generating unit
1170 Display data filtering calculation unit
1180 Diagnosis unit
1190 Display unit

1. A data display system comprising:
a storage unit that stores data from sensors installed on a machine;
a parameter setting unit that accepts input of a parameter for processing the data;
a diagnosis unit that displays, on a display unit, results of processing of the data allowed to be compared before and after modifying a parameter; and
a display data filtering calculation unit that changes a scope of data to display for comparison by selecting a criterion to filter data to display by an analysis operator to analyze the data.

2. The data display system according to claim 1,
wherein the display data filtering calculation unit changes the scope of data to display according to an extent to which a parameter is modified, specified as a criterion to filter data to display, and a result of processing of the data by modifying the parameter.

3. The data display system according to claim 1,
wherein the display data filtering calculation unit takes it as a criterion to filter data to display that a value change has occurred in a trend graph before and after parameter adjustment.

4. The data display system according to claim 1,
wherein the display data filtering calculation unit takes a change of an abnormality degree change rate before and after parameter adjustment as a criterion to filter data to display.

5. The data display system according to claim 4,
wherein the display data filtering calculation unit takes a ratio of a change amount of abnormality degree to a change amount of a parameter as a criterion to filter data to display.

6. The data display system according to claim 1,
wherein the display data filtering calculation unit takes it as a criterion to filter data to display that an abnormality degree has been made larger or smaller than a specified threshold value by the parameter adjustment.

7. The data display system according to claim 1,
wherein the display data filtering calculation unit takes it as a criterion to filter data to display that an abnormality degree change before and after parameter adjustment is not monotonically increasing or decreasing.

8. The data display system according to claim 1,
wherein the display data filtering calculation unit takes it as a criterion to filter data to display that the machine is in a specified operating mode.

9. The data display system according to claim 1,
wherein the specified operating mode is a transient period during startup of the machine or an idling period.
